(19) United States
(12) Patent Application Publication
(10) Pub. No.: US 2015/0269871 A1
(43) Pub. Date: Sep. 24, 2015

(54) Azcuna Door Hanger

(71) Applicants: Phillip Joseph Azcuna, Jr., San Diego, CA (US); Honey Michelle Guzmana Azcuna, San Diego, CA (US)

(72) Inventors: Phillip Joseph Azcuna, Jr., San Diego, CA (US); Honey Michelle Guzmana Azcuna, San Diego, CA (US)

(21) Appl. No.: 14/155,672

(22) Filed: Mar. 24, 2014

(51) Int. Cl. G09F 3/02; G09F 11/00

(52) U.S. Cl. CPC G09F 3/02; G09F 11/00

(57) ABSTRACT

An “Azcuna Door Hanger” is an improved door or doorknob hanger modified with a clock interface made of movable parts to allow the clients/customers to communicate a specific time of requested service/services to the staff. It can be used in many businesses like hotels, motels, hospitals (private rooms), dormitories, etc.

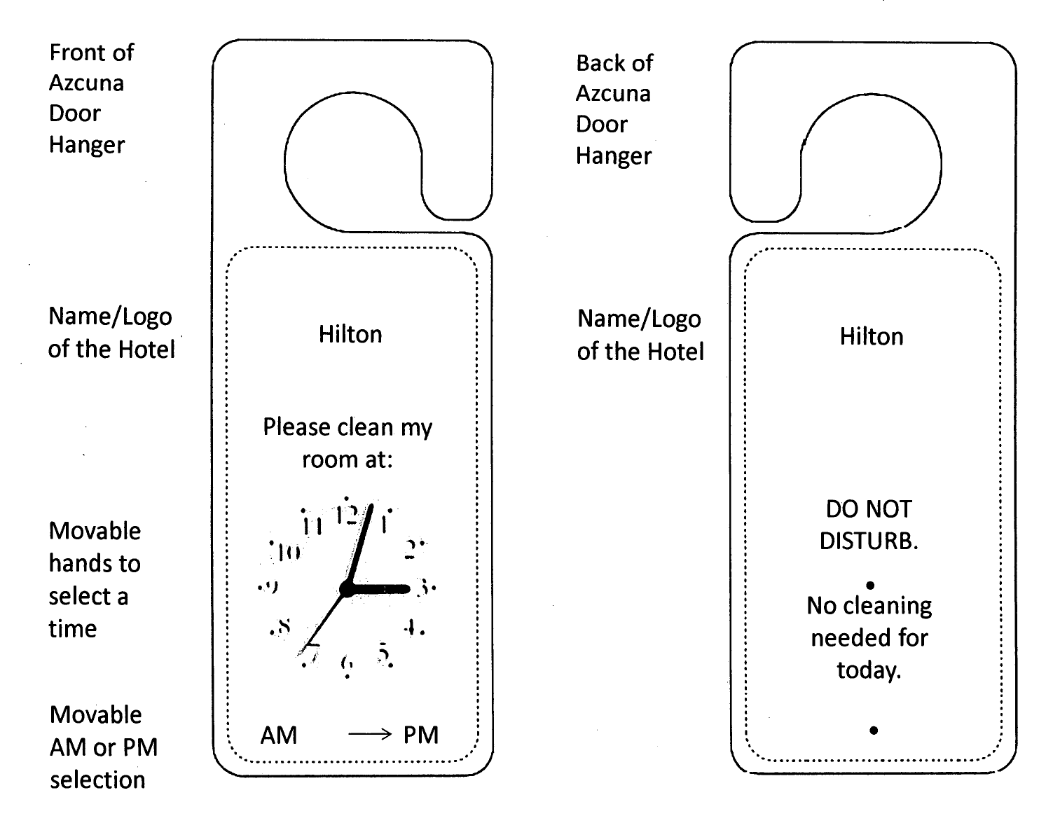

### BACKGROUND

Hotel guests that stay more than one night are the target audience (“guests”). Guests typically have to communicate to hotel staff either via phone call to front desk or in person. This invention gives another, more efficient option. More detail is in the detailed description of invention section.

### SUMMARY

An “Azcuna Door Hanger” is an improved door or doorknob hanger modified with a clock interface made of movable parts to allow the user to communicate a specific time to the staff.

### FIGURES

A drawing is attached that shows the front and back of the drawing, with short descriptions beside the key concepts/components.

### DETAILED DESCRIPTION OF INVENTION

The “Azcuna Door Hanger” shall be made as a normal door hanger, consisting of paper, cardboard, plastic, and/or other material needed for configuration. It will consist of two sides, a front and a back. The front will have hotel name, clock display, AM/PM display, and general instruction. See attached drawing for an example. The back will have hotel name, fasteners to keep the components in place, and general instruction. See attached drawing for example. It may be used as a tool for hotel guests to communicate with hotel staff when the room is available to be cleaned. The user will manually manipulate the provided hour and minute hands of the clock and the selection of AM or PM to convey this message. Guest will hang on door (knob) facing outward. Hotel staff will walk around all rooms and take note of times.

This is an improvement for the guest, since they don't need to call or spend extra time contacting staff This saves staff time since they don't need to waste time answering phone calls and can spend that time more efficiently. Staff will still have to add time to collect guest cleaning time requests, but this will be more efficient overall.
This specification contains no new matter.

1. Clock attached to lower half of door hanger.

2. Hour and minute hands of clock that are able to be manipulated

3. Dial to point to “AM” or “PM”
